(19) United States
(12) Patent Application Publication
(10) Pub. No.: US 2026/0350356 A1
(43) Pub. Date: Nov. 5, 2026

(54) Method, System, and Computer Program Product for Pretrained Dual Transformers for Bipartite Graphs

(71) Applicant: Visa International Service Association, San Francisco, CA (US)

(72) Inventors: Xin Dai, Fremont, CA (US); Zhongfang Zhuang, San Jose, CA (US); Yujie Fan, Cleveland Heights, OH (US); Michael Yeh, Newark, CA (US); Wei Zhang, Fremont, CA (US); Junpeng Wang, Santa Clara, CA (US); Yan Zheng, Los Gatos, CA (US); Liang Wang, San Jose, CA (US); Shubham Jain, San Mateo, CA (US)

(21) Appl. No.: 19/487,117

(22) PCT Filed: May 28, 2024
(86) PCT No.: PCT/US2024/031246

§ 371 Date: Nov. 24, 2025

Related U.S. Application Data
(60) Provisional application No. 63/469,128, filed on May 26, 2023.

(51) Int. Cl. G06N 3/045

(52) U.S. Cl. CPC G06N 3/045

(57) ABSTRACT

Methods, systems, and computer program products are provided for pretrained dual transformers for bipartite graphs. Graph data of a bipartite graph including first nodes/entities, second nodes/entities, and edges is received. A first entity context of each first entity includes second entities connected thereto by the edge(s). A second entity context of each second entity/node comprises first entities connected thereto the edge(s). First embeddings for each first entity are generated. First encoded representations for each first entity are generated based on the first entity context and a first transformer encoder. Second embeddings for each second entity are generated. Second encoded representations for each second entity are generated based on the second entity context and a second transformer encoder. The first embeddings and the first transformer encoder are adjusted based on a first contrastive loss. The second embeddings and the second transformer encoder are adjusted based on a second contrastive loss.

### CROSS REFERENCE TO RELATED APPLICATIONS

This application is the United States national phase of International Application No. PCT/US24/31246, filed May 28, 2024, and claims priority to U.S. Provisional Patent Application No. 63/469,128, filed May 26, 2023, the disclosures of which are hereby incorporated by reference in their entireties.

### BACKGROUND

### 1. Technical Field

This disclosure relates generally to machine learning for graph data and, in some non-limiting embodiments or aspects, to methods, systems, and computer program products for pretrained dual transformers for bipartite graphs.

### 2. Technical Considerations

Certain activities of users (e.g., online activities, offline activities, and/or the like) may be represented as data indicating interactions between users and content (e.g., visiting places, purchasing products, reading news articles, viewing multimedia content, rating multimedia content, posting comments about events, and/or the like). Insights about the user, the user's behavior, the content, or the content's properties can be learned based on these user-content interactions. Certain machine learning models have been used to attempt to perform a specific task (e.g., generate a specific type of prediction, such as predicting content to recommend to the user).

However, machine learning models trained solely to fit a specific task's objective may suffer from data sparsity, which may ultimately limit the performance of the machine learning models. Moreover, attempts to apply self-supervised learning to learn contextual knowledge only learn contextual knowledge from a single perspective, since machine learning models for this type of self-supervised learning were developed for images (e.g., computer vision) or text (e.g., natural language processing), in which context is inherent in the image or text, respectively.

### SUMMARY

Accordingly, provided are improved methods, systems, and computer program products for pretrained dual transformers for bipartite graphs (e.g., that overcome some or all of the deficiencies identified above).

According to non-limiting embodiments or aspects, provided are methods for pretrained dual transformers for bipartite graphs. An example method may include receiving graph data associated with a bipartite graph, which may include a plurality of first nodes, a plurality of second nodes, and a plurality of edges. Each first node of the plurality of first nodes may be associated with a first entity of a plurality of first entities.

Each second node of the plurality of second nodes may be associated with a second entity of a plurality of second entities. Each edge of the plurality of edges may be associated with an interaction between a respective first entity of the plurality of first entities and a respective second entity of the plurality of second entities. A first entity context of each first entity of the plurality of first entities may include all second entities of the plurality of second entities connected thereto by at least one edge of the plurality of edges. A second entity context of each second entity of the plurality of second entities may include all first entities of the plurality of first entities connected thereto by at least one edge of the plurality of edges. A plurality of first embeddings including a respective first embedding associated with each first entity of the plurality of first entities may be generated. A plurality of first encoded representations including a respective first encoded representation associated with each first entity of the plurality of first entities may be generated based on the first entity context of each first entity of the plurality of first entities and a first transformer encoder. A plurality of second embeddings including a respective second embedding associated with each second entity of the plurality of second entities may be generated. A plurality of second encoded representations including a respective second encoded representation associated with each second entity of the plurality of second entities may be generated based on the second entity context of each second entity of the plurality of second entities and a second transformer encoder. The plurality of first embeddings and the first transformer encoder may be adjusted based on a first contrastive loss between the plurality of first embeddings and the plurality of first encoded representations. The plurality of second embeddings and the second transformer encoder may be adjusted based on a second contrastive loss between the plurality of second embeddings and the plurality of second encoded representations.

In some non-limiting embodiments or aspects, generating the plurality of first encoded representations, generating the plurality of second encoded representations, adjusting the plurality of first embeddings and the first transformer encoder, and adjusting the plurality of second embeddings and the second transformer encoder may be iteratively repeated until at least one termination condition is satisfied.

In some non-limiting embodiments or aspects, a prediction may be generated based on the first embedding of a selected first entity of the plurality of first entities, the first entity context of the selected first entity, the first transformer encoder, and the second transformer encoder.

In some non-limiting embodiments or aspects, the plurality of first embeddings, the first transformer encoder, the plurality of second embeddings, and the second transformer encoder may be adjusted based on a total loss determined based on the prediction.

In some non-limiting embodiments or aspects, generating the prediction and adjusting the plurality of first embeddings, the first transformer encoder, the plurality of second embeddings, and the second transformer encoder may be iteratively repeated until at least one termination condition is satisfied.

In some non-limiting embodiments or aspects, the prediction may include a sequential prediction.

In some non-limiting embodiments or aspects, the plurality of first entities may include a plurality of users, and wherein the plurality of second entities may include a plurality of contents.

In some non-limiting embodiments or aspects, generating the plurality of first embeddings may include randomly initializing the plurality of first embeddings.

In some non-limiting embodiments or aspects, generating the plurality of second embeddings may include randomly initializing the plurality of second embeddings.

According to non-limiting embodiments or aspects, provided are systems for pretrained dual transformers for bipartite graphs. An example system may include at least one processor configured to receive graph data associated with a bipartite graph, which may include a plurality of first nodes, a plurality of second nodes, and a plurality of edges. Each first node of the plurality of first nodes may be associated with a first entity of a plurality of first entities. Each second node of the plurality of second nodes may be associated with a second entity of a plurality of second entities. Each edge of the plurality of edges may be associated with an interaction between a respective first entity of the plurality of first entities and a respective second entity of the plurality of second entities. A first entity context of each first entity of the plurality of first entities may include all second entities of the plurality of second entities connected thereto by at least one edge of the plurality of edges. A second entity context of each second entity of the plurality of second entities may include all first entities of the plurality of first entities connected thereto by at least one edge of the plurality of edges. A plurality of first embeddings including a respective first embedding associated with each first entity of the plurality of first entities may be generated. A plurality of first encoded representations including a respective first encoded representation associated with each first entity of the plurality of first entities may be generated based on the first entity context of each first entity of the plurality of first entities and a first transformer encoder. A plurality of second embeddings including a respective second embedding associated with each second entity of the plurality of second entities may be generated. A plurality of second encoded representations including a respective second encoded representation associated with each second entity of the plurality of second entities may be generated based on the second entity context of each second entity of the plurality of second entities and a second transformer encoder. The plurality of first embeddings and the first transformer encoder may be adjusted based on a first contrastive loss between the plurality of first embeddings and the plurality of first encoded representations. The plurality of second embeddings and the second transformer encoder may be adjusted based on a second contrastive loss between the plurality of second embeddings and the plurality of second encoded representations.

In some non-limiting embodiments or aspects, the at least one processor may be further configured to iteratively repeat generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

In some non-limiting embodiments or aspects, the at least one processor may be further configured to generate a prediction based on the first embedding of a selected first entity of the plurality of first entities, the first entity context of the selected first entity, the first transformer encoder, and the second transformer encoder.

In some non-limiting embodiments or aspects, the at least one processor may be further configured to adjust the plurality of first embeddings, the first transformer encoder, the plurality of second embeddings, and the second transformer encoder based on a total loss determined based on the prediction.

In some non-limiting embodiments or aspects, the at least one processor may be further configured to iteratively repeat generating the prediction and adjusting the plurality of first embeddings, the first transformer encoder, the plurality of second embeddings, and the second transformer encoder until at least one termination condition is satisfied.

In some non-limiting embodiments or aspects, the prediction may include a sequential prediction.

In some non-limiting embodiments or aspects, the plurality of first entities may include a plurality of users. Additionally or alternatively, the plurality of second entities may include a plurality of contents.

In some non-limiting embodiments or aspects, generating the plurality of first embeddings may include randomly initializing the plurality of first embeddings.

In some non-limiting embodiments or aspects, generating the plurality of second embeddings may include randomly initializing the plurality of second embeddings.

According to non-limiting embodiments or aspects, provided are computer program products for pretrained dual transformers for bipartite graphs. An example computer program product may include at least one non-transitory computer-readable medium including program instructions that, when executed by at least one processor, cause the at least one processor to receive graph data associated with a bipartite graph, which may include a plurality of first nodes, a plurality of second nodes, and a plurality of edges. Each first node of the plurality of first nodes may be associated with a first entity of a plurality of first entities. Each second node of the plurality of second nodes may be associated with a second entity of a plurality of second entities. Each edge of the plurality of edges may be associated with an interaction between a respective first entity of the plurality of first entities and a respective second entity of the plurality of second entities. A first entity context of each first entity of the plurality of first entities may include all second entities of the plurality of second entities connected thereto by at least one edge of the plurality of edges. A second entity context of each second entity of the plurality of second entities may include all first entities of the plurality of first entities connected thereto by at least one edge of the plurality of edges. A plurality of first embeddings including a respective first embedding associated with each first entity of the plurality of first entities may be generated. A plurality of first encoded representations including a respective first encoded representation associated with each first entity of the plurality of first entities may be generated based on the first entity context of each first entity of the plurality of first entities and a first transformer encoder. A plurality of second embeddings including a respective second embedding associated with each second entity of the plurality of second entities may be generated. A plurality of second encoded representations including a respective second encoded representation associated with each second entity of the plurality of second entities may be generated based on the second entity context of each second entity of the plurality of second entities and a second transformer encoder. The plurality of first embeddings and the first transformer encoder may be adjusted based on a first contrastive loss between the plurality of first embeddings and the plurality of first encoded representations. The plurality of second embeddings and the second transformer encoder may be adjusted based on a second contrastive loss between the plurality of second embeddings and the plurality of second encoded representations.

In some non-limiting embodiments or aspects, the instructions, when executed by the at least one processor, may further cause the at least one processor to iteratively repeat generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

In some non-limiting embodiments or aspects, the instructions, when executed by the at least one processor, may further cause the at least one processor to generate a prediction based on the first embedding of a selected first entity of the plurality of first entities, the first entity context of the selected first entity, the first transformer encoder, and the second transformer encoder.

In some non-limiting embodiments or aspects, the instructions, when executed by the at least one processor, may further cause the at least one processor to adjust the plurality of first embeddings, the first transformer encoder, the plurality of second embeddings, and the second transformer encoder based on a total loss determined based on the prediction.

In some non-limiting embodiments or aspects, the instructions, when executed by the at least one processor, may further cause the at least one processor to iteratively repeat generating the prediction and adjusting the plurality of first embeddings, the first transformer encoder, the plurality of second embeddings, and the second transformer encoder until at least one termination condition is satisfied.

In some non-limiting embodiments or aspects, the prediction may include a sequential prediction.

In some non-limiting embodiments or aspects, the plurality of first entities may include a plurality of users. Additionally or alternatively, the plurality of second entities may include a plurality of contents.

In some non-limiting embodiments or aspects, generating the plurality of first embeddings may include randomly initializing the plurality of first embeddings.

In some non-limiting embodiments or aspects, generating the plurality of second embeddings may include randomly initializing the plurality of second embeddings.

According to non-limiting embodiments or aspects, provided are systems for pretrained dual transformers for bipartite graphs. An example system may include at least one processor configured to perform any of the methods described herein.

According to non-limiting embodiments or aspects, provided are computer program products for pretrained dual transformers for bipartite graphs. An example computer program product may include at least one non-transitory computer-readable medium including program instructions that, when executed by at least one processor, cause the at least one processor to perform any of the methods described herein.

Further non-limiting embodiments or aspects are set forth in the following numbered clauses:

Clause 1: A computer-implemented method, comprising: receiving, with at least one processor, graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges; generating, with at least one processor, a plurality of first embeddings comprising a respective first embedding associated with each first entity of the plurality of first entities; generating, with at least one processor, a plurality of first encoded representations comprising a respective first encoded representation associated with each first entity of the plurality of first entities based on the first entity context of each first entity of the plurality of first entities and a first transformer encoder; generating, with at least one processor, a plurality of second embeddings comprising a respective second embedding associated with each second entity of the plurality of second entities; generating, with at least one processor, a plurality of second encoded representations comprising a respective second encoded representation associated with each second entity of the plurality of second entities based on the second entity context of each second entity of the plurality of second entities and a second transformer encoder; adjusting, with at least one processor, the plurality of first embeddings and the first transformer encoder based on a first contrastive loss between the plurality of first embeddings and the plurality of first encoded representations; and adjusting, with at least one processor, the plurality of second embeddings and the second transformer encoder based on a second contrastive loss between the plurality of second embeddings and the plurality of second encoded representations.

Clause 2: The method of clause 1, further comprising: iteratively repeating, with at least one processor, generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

Clause 3: The method of clause 1 or clause 2, further comprising: generating, with at least one processor, a prediction based on the first embedding of a selected first entity of the plurality of first entities, the first entity context of the selected first entity, the first transformer encoder, and the second transformer encoder.

Clause 4: The method of any of clauses 1-3, further comprising: adjusting, with at least one processor, the plurality of first embeddings, the first transformer encoder, the plurality of second embeddings, and the second transformer encoder based on a total loss determined based on the prediction.

Clause 5: The method of any of clauses 1-4, further comprising: iteratively repeating, with at least one processor, generating the prediction and adjusting the plurality of first embeddings, the first transformer encoder, the plurality of second embeddings, and the second transformer encoder until at least one termination condition is satisfied.

Clause 6: The method of any of clauses 1-5, wherein the prediction comprises a sequential prediction.

Clause 7: The method of any of clauses 1-6, wherein the plurality of first entities comprises a plurality of users, and wherein the plurality of second entities comprises a plurality of contents.

Clause 8: The method of any of clauses 1-7, wherein generating the plurality of first embeddings comprises randomly initializing the plurality of first embeddings.

Clause 9: The method of any of clauses 1-8, wherein generating the plurality of second embeddings comprises randomly initializing the plurality of second embeddings.

Clause 10: A system, comprising: at least one processor configured to: receive graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges; generate a plurality of first embeddings comprising a respective first embedding associated with each first entity of the plurality of first entities; generate a plurality of first encoded representations comprising a respective first encoded representation associated with each first entity of the plurality of first entities based on the first entity context of each first entity of the plurality of first entities and a first transformer encoder; generate a plurality of second embeddings comprising a respective second embedding associated with each second entity of the plurality of second entities; generate a plurality of second encoded representations comprising a respective second encoded representation associated with each second entity of the plurality of second entities based on the second entity context of each second entity of the plurality of second entities and a second transformer encoder; adjust the plurality of first embeddings and the first transformer encoder based on a first contrastive loss between the plurality of first embeddings and the plurality of first encoded representations; and adjust the plurality of second embeddings and the second transformer encoder based on a second contrastive loss between the plurality of second embeddings and the plurality of second encoded representations.

Clause 11: The system of clause 10, wherein the at least one processor is further configured to: iteratively repeat generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

Clause 12: The system of clause 10 or clause 11, wherein the at least one processor is further configured to: generate a prediction based on the first embedding of a selected first entity of the plurality of first entities, the first entity context of the selected first entity, the first transformer encoder, and the second transformer encoder.

Clause 13: The system of any of clauses 10-12, wherein the at least one processor is further configured to: adjust the plurality of first embeddings, the first transformer encoder, the plurality of second embeddings, and the second transformer encoder based on a total loss determined based on the prediction.

Clause 14: The system of any of clauses 10-13, wherein the at least one processor is further configured to: iteratively repeat generating the prediction and adjusting the plurality of first embeddings, the first transformer encoder, the plurality of second embeddings, and the second transformer encoder until at least one termination condition is satisfied.

Clause 15: The system of any of clauses 10-14, wherein the prediction comprises a sequential prediction.

Clause 16: The system of any of clauses 10-15, wherein the plurality of first entities comprises a plurality of users, and wherein the plurality of second entities comprises a plurality of contents.

Clause 17: The system of any of clauses 10-16, wherein generating the plurality of first embeddings comprises randomly initializing the plurality of first embeddings.

Clause 18: The system of any of clauses 10-17, wherein generating the plurality of second embeddings comprises randomly initializing the plurality of second embeddings.

Clause 19: A computer program product comprising at least one non-transitory computer-readable medium including program instructions that, when executed by at least one processor, cause the at least one processor to: receive graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges; generate a plurality of first embeddings comprising a respective first embedding associated with each first entity of the plurality of first entities; generate a plurality of first encoded representations comprising a respective first encoded representation associated with each first entity of the plurality of first entities based on the first entity context of each first entity of the plurality of first entities and a first transformer encoder; generate a plurality of second embeddings comprising a respective second embedding associated with each second entity of the plurality of second entities; generate a plurality of second encoded representations comprising a respective second encoded representation associated with each second entity of the plurality of second entities based on the second entity context of each second entity of the plurality of second entities and a second transformer encoder; adjust the plurality of first embeddings and the first transformer encoder based on a first contrastive loss between the plurality of first embeddings and the plurality of first encoded representations; and adjust the plurality of second embeddings and the second transformer encoder based on a second contrastive loss between the plurality of second embeddings and the plurality of second encoded representations.

Clause 20: The computer program product of claim 19, wherein the instructions, when executed by the at least one processor, further cause the at least one processor to: generate a prediction based on the first embedding of a selected first entity of the plurality of first entities, the first entity context of the selected first entity, the first transformer encoder, and the second transformer encoder.

Clause 21: A system comprising: at least one processor configured to perform the method of any of clauses 1-9.

Clause 22: A computer program product comprising at least one non-transitory computer-readable medium including program instructions that, when executed by at least one processor, cause the at least one processor to perform the method of any of clauses 1-9.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example system for pretrained dual transformers for bipartite graphs, according to some non-limiting embodiments or aspects;

FIG. 2 is a flow diagram of an example method for pretrained dual transformers for bipartite graphs, according to some non-limiting embodiments or aspects;

FIG. 3 is a diagram of an example payment processing network in which methods, systems, and/or computer program products, described herein, may be implemented, according to some non-limiting embodiments or aspects;

FIG. 4 is a schematic diagram of example components of one or more devices of FIG. 1 and/or FIG. 3, according to some non-limiting embodiments or aspects;

FIG. 5A is a schematic diagram of an example bipartite graph, according to some non-limiting embodiments or aspects;

FIGS. 5B and 5C are schematic diagrams of example contexts for entities of a bipartite graph, according to some non-limiting embodiments or aspects;

FIG. 6 is a schematic diagram of an example implementation of pretrained dual transformers for bipartite graphs, according to some non-limiting embodiments or aspects; and

FIG. 7 is a schematic diagram of an example implementation of pretrained dual transformers for bipartite graphs, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures.

However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature.

Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for machine learning for graph data, including, but not limited to, pretrained dual transformers for bipartite graphs. For example, non-limiting embodiments or aspects of the disclosed subject matter provide receiving graph data associated with a bipartite graph comprising a plurality of first nodes, a plurality of second nodes, and a plurality of edges. Each first node of the plurality of first nodes may be associated with a first entity of a plurality of first entities (e.g., users). Each second node of the plurality of second nodes may be associated with a second entity of a plurality of second entities (e.g., contents). Each edge of the plurality of edges may be associated with an interaction between a respective first entity (e.g., user) and a respective second entity (e.g., content). A first entity context (e.g., user context) of each first entity may include all second entities (e.g., all contents) connected thereto by at least one edge. A second entity context (e.g., content context) of each second entity of the plurality of second entities may include all first entities (e.g., users) connected thereto by at least one edge. A plurality of first embeddings comprising a respective first embedding associated with each first entity of the plurality of first entities may be generated. A plurality of first encoded representations including a respective first encoded representation associated with each first entity of the plurality of first entities may be generated based on the first entity context of each first entity of the plurality of first entities and a first transformer encoder. A plurality of second embeddings including a respective second embedding associated with each second entity of the plurality of second entities may be generated. A plurality of second encoded representations including a respective second encoded representation associated with each second entity of the plurality of second entities may be generated based on the second entity context of each second entity of the plurality of second entities and a second transformer encoder. The plurality of first embeddings and the first transformer encoder may be adjusted (e.g., trained) based on a first contrastive loss between the plurality of first embeddings and the plurality of first encoded representations. The plurality of second embeddings and the second transformer encoder may be adjusted (e.g., trained) based on a second contrastive loss between the plurality of second embeddings and the plurality of second encoded representations. As such, the disclosed subject matter enables learning contextual knowledge from a dataset (e.g., the graph data associated with the bipartite graph) from two different perspectives (e.g., the user-side and the content-side), which is not possible with a single type of transformer. This dual perspective may be advantageous when the input is associated with a bipartite graph (e.g., in a user-content bipartite graph, the context of a user's activity is not limited to the user's personal history, and the contents each have their own context), as opposed to other use cases such as image or text inputs (e.g., in which the context is inherent in the image or text). Additionally, the disclosed subject matter enables pre-training in an unsupervised manner (e.g., based on the contrastive loss between embeddings and encoded representations), which may be advantageous when labeled data is scarce or unavailable. In some non-limiting embodiments or aspects, the disclosed subject matter provides generating a prediction based on the first embedding of a selected first entity of the plurality of first entities (e.g., a selected user), the first entity context of the selected first entity, the first transformer encoder, and the second transformer encoder. Additionally, the plurality of first embeddings, the first transformer encoder, the plurality of second embeddings, and the second transformer encoder may be adjusted based on a total loss determined based on the prediction. As such, the disclosed subject matter enables fine-tuning for a specific downstream task (e.g., a prediction, such as sequential recommendation, fraud detection, and/or the like) after pre-training.

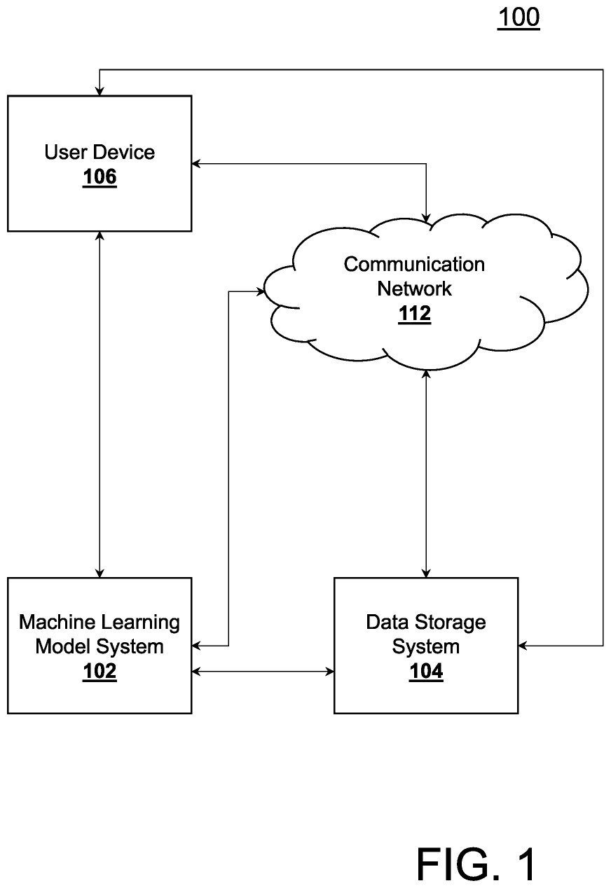

Referring now to FIG. 1, shown is an example system 100 for pretrained dual transformers for bipartite graphs, according to some non-limiting embodiments or aspects. As shown in FIG. 1, system 100 may include machine learning model system 102, data storage system 104, user device 106, and/or communication network 112.

Machine learning model system 102 may include one or more devices capable of receiving information from and/or communicating information to data storage system 104 and/or user device 106 (e.g., directly via wired or wireless communication connection, indirectly via communication network 112, and/or the like). For example, machine learning model system 102 may include a computing device, such as a server, a group of servers, a desktop computer, a portable computer, and/or other like devices. In some non-limiting embodiments or aspects, machine learning model system 102 may be in communication with a data storage device (e.g., data storage system 104), which may be local or remote to machine learning model system 102. In some non-limiting embodiments or aspects, machine learning model system 102 may be capable of receiving information from, storing information in, communicating information to, or searching information stored in the data storage device (e.g., data storage system 104).

Data storage system 104 may include one or more devices capable of receiving information from and/or communicating information to machine learning model system 102 and/or user device 106 (e.g., directly via wired or wireless communication connection, indirectly via communication network 112, and/or the like). For example, data storage system 104 may include a computing device, such as a server, a group of servers, and/or other like devices. In some non-limiting embodiments or aspects, data storage system 104 may include a data storage device. In some non-limiting embodiments or aspects, data storage system 104 may be capable of receiving information from, storing information in, communicating information to, or searching information stored in the data storage device. In some non-limiting embodiments or aspects, data storage system 104 may be part of machine learning model system 102 and/or part of the same system as machine learning model system 102.

User device 106 may include one or more devices capable of receiving information from and/or communicating information to machine learning model system 102 and/or data storage system 104 (e.g., directly via wired or wireless communication connection, indirectly via communication network 112, and/or the like). For example, user device 106 may include a computing device, such as a mobile device, a portable computer, a desktop computer, and/or other like devices. Additionally or alternatively, each user device 106 may include a device capable of receiving information from and/or communicating information to other user devices 106 (e.g., directly via wired or wireless communication connection, indirectly via communication network 112, and/or the like). In some non-limiting embodiments or aspects, user device 106 may be part of machine learning model system 102 and/or part of the same system as machine learning model system 102.

Communication network 112 may include one or more wired and/or wireless networks. For example, communication network 112 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

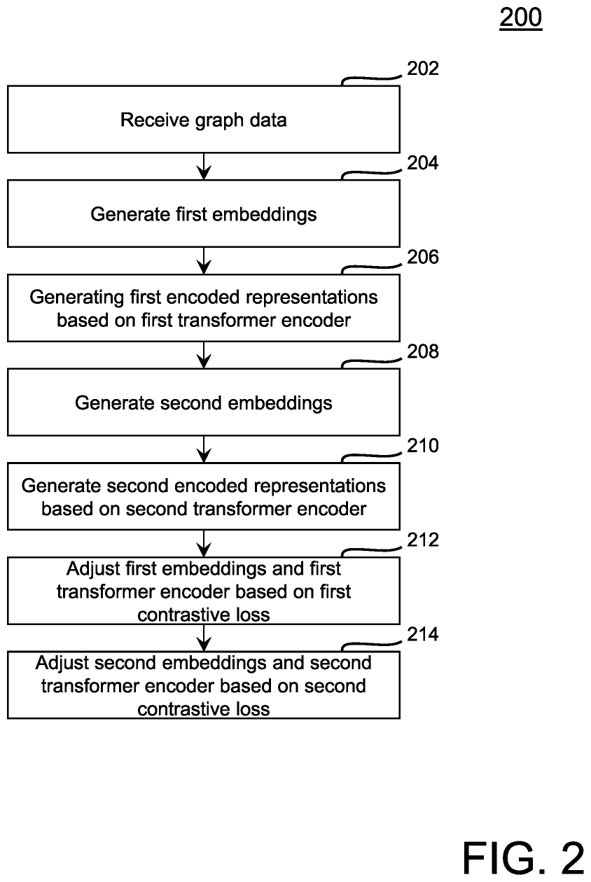

Referring now to FIG. 2, shown is an example method 200 for pretrained dual transformers for bipartite graphs according to some non-limiting embodiments or aspects. The steps shown in FIG. 2 are for example purposes only. It will be appreciated that additional, fewer, different, and/or a different order of steps may be used in non-limiting embodiments or aspects. In some non-limiting embodiments or aspects, one or more of the steps of method 200 may be performed (e.g., completely, partially, and/or the like) by machine learning model system 102 (e.g., one or more devices of machine learning model system 102). In some non-limiting embodiments or aspects, one or more of the steps of method 200 may be performed (e.g., completely, partially, and/or the like) by another system, another device, another group of systems, or another group of devices, separate from or including machine learning model system 102, such as data storage system 104, user device 106, and/or the like.

As shown in FIG. 2, at step 202, method 200 may include receiving graph data.

For example, machine learning model system 102 may receive graph data (e.g., from data storage system 104).

In some non-limiting embodiments or aspects, the graph data may be associated with a bipartite graph comprising a plurality of first nodes, a plurality of second nodes, and a plurality of edges. Each first node of the plurality of first nodes may be associated with a first entity of a plurality of first entities. Each second node of the plurality of second nodes may be associated with a second entity of a plurality of second entities. Each edge of the plurality of edges may be associated with an interaction between a respective first entity of the plurality of first entities and a respective second entity of the plurality of second entities.

In some non-limiting embodiments or aspects, a first entity context of each first entity of the plurality of first entities may include all second entities of the plurality of second entities connected thereto by at least one edge of the plurality of edges. Additionally or alternatively, a second entity context of each second entity of the plurality of second entities may include all first entities of the plurality of first entities connected thereto by at least one edge of the plurality of edges.

As shown in FIG. 2, at step 204, method 200 may include generating first embeddings. For example, machine learning model system 102 may generate a plurality of first embeddings comprising a respective first embedding associated with each first entity of the plurality of first entities.

In some non-limiting embodiments or aspects, generating the plurality of first embeddings may include randomly initializing the plurality of first embeddings.

As shown in FIG. 2, at step 206, method 200 may include generating first encoded representations based on a first transformer encoder. For example, machine learning model system 102 may generate a plurality of first encoded representations comprising a respective first encoded representation associated with each first entity of the plurality of first entities based on the first entity context of each first entity of the plurality of first entities and a first transformer encoder.

As shown in FIG. 2, at step 208, method 200 may include generating second embeddings. For example, machine learning model system 102 may generate a plurality of second embeddings comprising a respective second embedding associated with each second entity of the plurality of second entities.

In some non-limiting embodiments or aspects, generating the plurality of second embeddings may include randomly initializing the plurality of second embeddings.

As shown in FIG. 2, at step 210, method 200 may include generating second encoded representations based on a second transformer encoder. For example, machine learning model system 102 may generate a plurality of second encoded representations comprising a respective second encoded representation associated with each second entity of the plurality of second entities based on the second entity context of each second entity of the plurality of second entities and a second transformer encoder.

As shown in FIG. 2, at step 212, method 200 may include adjusting (e.g., training) the first embeddings and the first transformer encoder based on a first contrastive loss. For example, machine learning model system 102 may adjust (e.g., train) the plurality of first embeddings and the first transformer encoder based on a first contrastive loss between the plurality of first embeddings and the plurality of first encoded representations.

As shown in FIG. 2, at step 214, method 200 may include adjusting (e.g., training) the second embeddings and the second transformer encoder based on second contrastive loss. For example, machine learning model system 102 may adjust (e.g., train) the plurality of second embeddings and the second transformer encoder based on a second contrastive loss between the plurality of second embeddings and the plurality of second encoded representations.

In some non-limiting embodiments or aspects, at least some of the aforementioned steps may be iteratively repeated. For example, machine learning model system 102 may iteratively repeat generating the plurality of first encoded representations (e.g., step 206), generating the plurality of second encoded representations (e.g., step 210), adjusting the plurality of first embeddings and the first transformer encoder (e.g., step 212), and adjusting the plurality of second embeddings and the second transformer encoder (e.g., step 212) until at least one termination condition is satisfied.

In some non-limiting embodiments or aspects, machine learning model system 102 may generate a prediction based on the first embedding of a selected first entity of the plurality of first entities, the first entity context of the selected first entity, the first transformer encoder, the second transformer encoder, any combination thereof, and/or the like.

In some non-limiting embodiments or aspects, machine learning model system 102 may adjust (e.g., train) the plurality of first embeddings, the first transformer encoder, the plurality of second embeddings, and the second transformer encoder based on a total loss determined based on the prediction.

In some non-limiting embodiments or aspects, machine learning model system 102 may iteratively repeat generating the prediction and adjusting the plurality of first embeddings, the first transformer encoder, the plurality of second embeddings, and the second transformer encoder until at least one termination condition is satisfied.

In some non-limiting embodiments or aspects, the prediction may include a sequential prediction.

In some non-limiting embodiments or aspects, the plurality of first entities may include a plurality of users. Additionally or alternatively, the plurality of second entities may include a plurality of contents.

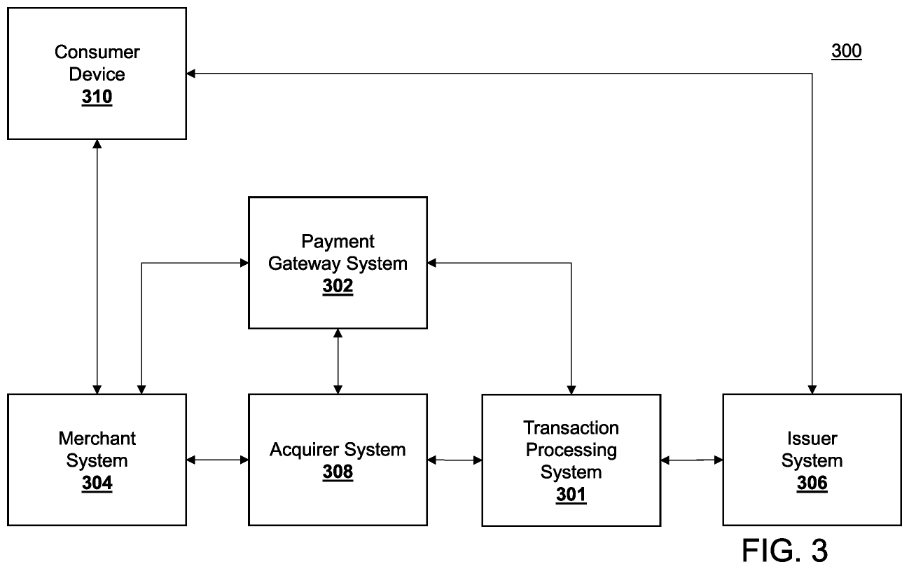

Referring now to FIG. 3, depicted is a diagram of an example payment processing network 300, according to non-limiting embodiments or aspects. In some non-limiting embodiments or aspects, payment processing network 300 may be used in conjunction with the systems, methods, and/or computer program products described herein, and/or the systems, methods, and/or computer program products described herein may be implemented in payment processing network 300. As shown in FIG. 3, payment processing network 300 may include transaction processing system 301, payment gateway system 302, merchant system 304, issuer system 306, acquirer system 308, and/or consumer device 310. In some non-limiting embodiments or aspects, each of machine learning model system 102, data storage system 104, and/or user device 106 of FIG. 1 may be implemented by (e.g., part of) transaction processing system 301. In some non-limiting embodiments or aspects, at least one of machine learning model system 102, data storage system 104, and/or user device 106 of FIG. 1 may be implemented by (e.g., part of) another system, another device, another group of systems, or another group of devices, separate from or including transaction processing system 301, such as merchant system 304, issuer system 306, acquirer system 308, consumer device 310, and/or the like. For example, user device 106 may be implemented by (e.g., part of) at least one of payment gateway system 302, merchant system 304, issuer system 306, acquirer system 308, and/or consumer device 310. Additionally or alternatively, for example, data storage system 104 may be implemented by (e.g., part of) at least one of payment gateway system 302, merchant system 304, issuer system 306, acquirer system 308, and/or consumer device 310.

Transaction processing system 301 may include one or more devices capable of receiving information from and/or communicating information to payment gateway system 302, merchant system 304, issuer system 306, acquirer system 308, consumer device 310, and/or the like (e.g., directly, indirectly, via a public and/or private communication network connection, and/or the like). For example, as shown in FIG. 3, transaction processing system 301 may be in communication with one or more issuer systems (e.g., issuer system 306), one or more acquirer systems (e.g., acquirer system 308), and/or one or more payment gateway systems (e.g., payment gateway system 302). Although only a single issuer system 306, single acquirer system 308, and single payment gateway system 302 are shown, it will be appreciated that transaction processing system 301 may be in communication with a plurality of issuer systems, a plurality of acquirer systems, and/or a plurality of payment gateways. In some non-limiting embodiments or aspects, transaction processing system 301 may include a computing device, such as a server (e.g., a transaction processing server), a group of servers, and/or other like devices. In some non-limiting embodiments or aspects, transaction processing system 301 may be in communication with a data storage device, which may be local or remote to transaction processing system 301. In some non-limiting embodiments or aspects, transaction processing system 301 may be capable of receiving information from, storing information in, communicating information to, or searching information stored in the data storage device. In some non-limiting embodiments or aspects, transaction processing system 301 may be associated with a transaction service provider, as described herein. In some non-limiting embodiments or aspects, transaction processing system 301 may also operate as an issuer system such that both transaction processing system 301 and issuer system 306 are a single system and/or controlled by a single entity.

Payment gateway system 302 may include one or more devices capable of receiving information from and/or communicating information to transaction processing system 301, merchant system 304, issuer system 306, acquirer system 308, consumer device 310, and/or the like (e.g., directly, indirectly, via a public and/or private communication network connection, and/or the like). For example, as shown in FIG. 3, payment gateway system 302 may be in communication with one or more merchant systems (e.g., merchant system 304), one or more acquirer systems (e.g., acquirer system 308), and/or one or more transaction processing systems (e.g., transaction processing system 301). Although only a single merchant system 304, single acquirer system 308, and single transaction processing system 301 are shown, it will be appreciated that payment gateway system 302 may be in communication with a plurality of merchant systems, a plurality of acquirer systems, and/or a plurality of transaction processing systems. In some non-limiting embodiments or aspects, payment gateway system 302 may include a computing device, such as a server, a group of servers, and/or other like devices. In some non-limiting embodiments or aspects, payment gateway system 302 may be associated with a payment gateway, as described herein.

Merchant system 304 may include one or more devices capable of receiving information from and/or communicating information to transaction processing system 301, payment gateway system 302, issuer system 306, acquirer system 308, consumer device 310, and/or the like (e.g., directly, indirectly, via a public and/or private communication network connection, and/or the like). For example, as shown in FIG. 3, merchant system 304 may be in communication with one or more payment gateway systems (e.g., payment gateway system 302), one or more acquirer systems (e.g., acquirer system 308), and/or one or more consumer devices (e.g., consumer device 310). Although only a single payment gateway system 302, single acquirer system 308, and single consumer device 310 are shown, it will be appreciated that merchant system 304 may be in communication with a plurality of payment gateway systems, a plurality of acquirer systems, and/or a plurality of consumer devices. In some non-limiting embodiments or aspects, merchant system 304 may include a computing device, such as a server, a group of servers, a client device, a group of client devices, a POS device, a POS system, computers, computer systems, peripheral devices, and/or other like devices. In some non-limiting embodiments or aspects, merchant system 304 may be associated with a merchant, as described herein. In some non-limiting embodiments or aspects, merchant system 304 may include a device capable of receiving information from and/or communicating information to consumer device 310 via a short range communication connection (e.g., an NFC communication connection, an RFID communication connection, a Bluetooth® communication connection, a Zigbee® communication connection, and/or the like) with consumer device 310 and/or the like. In some non-limiting embodiments or aspects, merchant system 304 may include one or more client devices. For example, merchant system 304 may include a client device that allows a merchant to communicate information to transaction processing system 301 (e.g., via at least one of acquirer system 308 and/or payment gateway system 302). In some non-limiting embodiments or aspects, merchant system 304 (e.g., a client device thereof, a POS device thereof, and/or the like) may also operate as a payment gateway system such that both merchant system 304 and payment gateway system 302 are a single system and/or controlled by a single entity.

Issuer system 306 may include one or more devices capable of receiving information and/or communicating information to transaction processing system 301, payment gateway system 302, merchant system 304, acquirer system 308, consumer device 310, and/or the like (e.g., directly, indirectly, via a public and/or private communication network connection, and/or the like). For example, as shown in FIG. 3, issuer system 306 may be in communication with one or more transaction processing systems (e.g., transaction processing system 301) and/or one or more consumer devices (e.g., consumer device 310). Although only a single transaction processing system 301 and a single consumer device 310 are shown, it will be appreciated that issuer system 306 may be in communication with a plurality of transaction processing systems and/or a plurality of consumer devices 310. In some non-limiting embodiments or aspects, issuer system 306 may include a computing device, such as a server, a group of servers, and/or other like devices. In some non-limiting embodiments or aspects, issuer system 306 may be associated with an issuer institution, as described herein. For example, issuer system 306 may be associated with an issuer institution that issued a credit account, debit account, credit card, debit card, a payment device, and/or the like to a user associated with consumer device 310.

Acquirer system 308 may include one or more devices capable of receiving information from and/or communicating information to transaction processing system 301, payment gateway system 302, merchant system 304, issuer system 306, consumer device 310, and/or the like (e.g., directly, indirectly, via a public and/or private communication network connection, and/or the like). For example, as shown in FIG. 3, acquirer system 308 may be in communication with one or more transaction processing systems (e.g., transaction processing system 301), one or more payment gateway systems (e.g., payment gateway system 302), and/or one or more merchant systems (e.g., merchant system 304). Although only a single transaction processing system 301, a single payment gateway system 302, and a single merchant system 304 are shown, it will be appreciated that acquirer system 308 may be in communication with a plurality of transaction processing systems, a plurality of payment gateway systems, and/or a plurality of merchant systems. In some non-limiting embodiments or aspects, acquirer system 308 may include a computing device, such as a server, a group of servers, and/or other like devices. In some non-limiting embodiments or aspects, acquirer system 308 may be associated with an acquirer institution, as described herein.

Consumer device 310 may include one or more devices capable of receiving information from and/or communicating information to transaction processing system 301, payment gateway system 302, merchant system 304, issuer system 306, acquirer system 308, and/or the like (e.g., directly, indirectly, via a public and/or private communication network connection, and/or the like). For example, as shown in FIG. 3, consumer device 310 may be in communication with one or more merchant systems (e.g., merchant system 304) and/or one or more issuer systems (e.g., issuer system 306). Although only a single merchant system 304 and a single issuer system 306 are shown, it will be appreciated that consumer device 310 may be in communication with a plurality of merchant systems and/or a plurality of issuer systems. In some non-limiting embodiments or aspects, consumer device 310 may be associated with a user to whom a credit account, debit account, credit card, debit card, a payment device, and/or the like has been issued. In some non-limiting embodiments or aspects, user device 310 may include a computing device, such as a computer, a portable computer, a laptop computer, a tablet computer, a mobile device, a cellular phone, a smartphone, a wearable device (e.g., watches, glasses, lenses, clothing, and/or the like), a PDA, a client device, and/or other like devices. In some non-limiting embodiments or aspects, user device 310 may include a payment device, as described herein. In some non-limiting embodiments or aspects, consumer device 310 may include a device capable of receiving information from and/or communicating information to other customer devices 310 (e.g., directly, indirectly, via a public and/or private communication network connection, a short range communication connection, and/or the like). In some non-limiting embodiments or aspects, consumer device 310 may include a device capable of receiving information from and/or communicating information to merchant system 304 via a short range communication connection (e.g., an NFC communication connection, an RFID communication connection, a Bluetooth® communication connection, a Zigbee® communication connection, and/or the like) with merchant system 304 and/or the like. In some non-limiting embodiments or aspects, consumer device 310 may include a client device.

In some non-limiting embodiments or aspects, transaction processing system 301 may communicate with merchant system 304 directly (e.g., via a public and/or private communication network connection and/or the like). Additionally or alternatively, transaction processing system 301 may communicate with merchant system 304 through payment gateway 302 and/or acquirer system 308. In some non-limiting embodiments or aspects, an acquirer system 308 associated with merchant system 304 may operate as payment gateway 302 to facilitate the communication of transaction messages (e.g., authorization requests) from merchant system 304 to transaction processing system 301.

In some non-limiting embodiments or aspects, merchant system 304 may communicate with payment gateway 302 directly (e.g., via a public and/or private communication network connection and/or the like). For example, a merchant system 304 that includes a physical POS device may communicate with payment gateway 302 through a public or private network to conduct card-present transactions. As another example, a merchant system 304 that includes a server (e.g., a web server) may communicate with payment gateway 302 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a customer (e.g., accountholder associated with customer device 310 and/or the like) and/or transaction data associated with the transaction. For example, merchant system 304 (e.g., a client device of merchant system 304, a POS device of merchant system 304, and/or the like) may initiate the transaction, e.g., by generating an authorization request (e.g., in response to receiving the account identifier from a payment device and/or a portable financial device of the customer and/or the like). Merchant system 304 may communicate the authorization request to payment gateway 302 and/or acquirer system 308. In some non-limiting embodiments or aspects, payment gateway 302 may communicate the authorization request to acquirer system 308 and/or transaction processing system 301. Additionally or alternatively, acquirer system 308 (and/or payment gateway 302) may communicate the authorization request to transaction processing system 301. After receiving the authorization request from merchant system 304 that identifies the account identifier of the customer (e.g., the accountholder associated with consumer device 310 and/or the account identifier), transaction processing system 301 may communicate the authorization request to issuer system 306 (e.g., the issuer system that issued the payment device and/or account identifier). Issuer system 306 may determine an authorization decision (e.g., approve, deny, and/or the like) based on the authorization request, and/or issuer system 306 may generate an authorization response based on the authorization decision and/or the authorization request. Issuer system 306 may communicate the authorization response to transaction processing system 301.

Transaction processing system 301 may communicate the authorization response to acquirer system 308 and/or payment gateway 302. In some non-limiting embodiments or aspects, acquirer system 308 may communicate the authorization response to payment gateway 302 and/or merchant system 304. Additionally or alternatively, payment gateway 302 (and/or acquirer system 308) may communicate the authorization response to merchant system 304.

In some non-limiting embodiments or aspects, transaction processing system 301 and/or issuer system 306 may include at least one machine learning model (e.g., at least one of a fraud detection model, a risk detection model, a transaction authorization model, a credit approval model, a product recommendation model, a classifier model, an anomaly detection model, an authentication model, any combination thereof, and/or the like). For example, the machine learning model(s) may include at least one transformer encoder (e.g., pretrained dual transformers for bipartite graphs and/or the like), as described herein. Transaction processing system 301 and/or issuer system 306 may perform at least one task (e.g., generate a prediction and/or generate an embedding) based on the authorization request and the machine learning model(s). For example, performing the task(s) may include generating at least one prediction associated with fraud detection, risk detection, transaction authorization, credit approval, product recommendation, classification, anomaly detection, authentication, any combination thereof, and/or the like. In some non-limiting embodiments or aspects, transaction processing system 301 may communicate at least one message based on performing the task (e.g., generating the prediction and/or generate an embedding) to issuer system 306 (e.g., along with the authorization request). In some non-limiting embodiments or aspects, issuer system 306 may determine the authorization decision (e.g., approve, deny, and/or the like) based on the authorization request and the performance of the task (e.g., generation of the prediction and/or generation of the embedding).

For the purpose of illustration, clearing and/or settlement of a transaction may include generating a message (e.g., clearing message and/or the like) based on an account identifier of a customer (e.g., associated with customer device 310 and/or the like) and/or transaction data associated with the transaction. For example, merchant system 304 may generate at least one clearing message (e.g., a plurality of clearing messages, a batch of clearing messages, and/or the like). Merchant system 304 may communicate the clearing message(s) to acquirer system 308 (and/or payment gateway 302, which may communicate the clearing message(s) to acquirer system 308). Acquirer system 308 may communicate the clearing message(s) to transaction processing system 301. Transaction processing system 301 may communicate the clearing message(s) to issuer system 306. Issuer system 306 may generate at least one settlement message based on the clearing message(s). In some non-limiting embodiments or aspects, issuer system 306 may communicate the settlement message(s) and/or funds to transaction processing system 301 (and/or a settlement bank system associated with transaction processing system 301), and transaction processing system 301 (and/or the settlement bank system) may communicate the settlement message(s) and/or funds to acquirer system 308. Additionally or alternatively, issuer system 306 may communicate the settlement message(s) and/or funds to acquirer system 308. In some non-limiting embodiments or aspects, acquirer system 308 may communicate settlement message(s) and/or funds to merchant system 304 (and/or an account associated with merchant system 304).

The systems and/or devices of FIG. 3 may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of payment processing network 300 may perform one or more functions described as being performed by another set of systems or another set of devices of payment processing network 300.

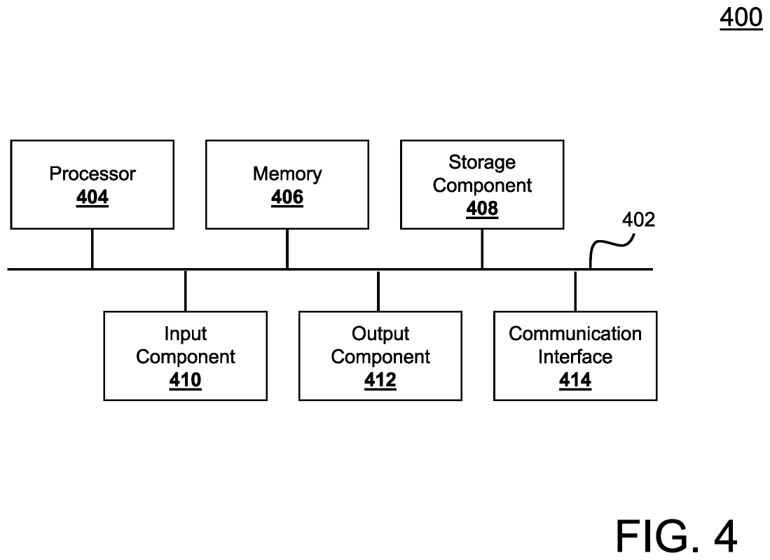

Referring now to FIG. 4, shown is a diagram of example components of a device 400 according to non-limiting embodiments. Device 400 may correspond to at least one of machine learning model system 102, data storage system 104, and/or user device 106 in FIG. 1 and/or at least one of transaction service provider system 302, issuer system 304, customer device 306, merchant system 308, and/or acquirer system 310 in FIG. 3, as an example. In some non-limiting embodiments, such systems or devices may include at least one device 400 and/or at least one component of device 400. The number and arrangement of components shown are provided as an example. In some non-limiting embodiments, device 400 may include additional components, fewer components, different components, or differently arranged components than those shown. Additionally or alternatively, a set of components (e.g., one or more components) of device 400 may perform one or more functions described as being performed by another set of components of device 400.

As shown in FIG. 4, device 400 may include a bus 402, a processor 404, memory 406, a storage component 408, an input component 410, an output component 412, and a communication interface 414. Bus 402 may include a component that permits communication among the components of device 400. In some non-limiting embodiments, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid-state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

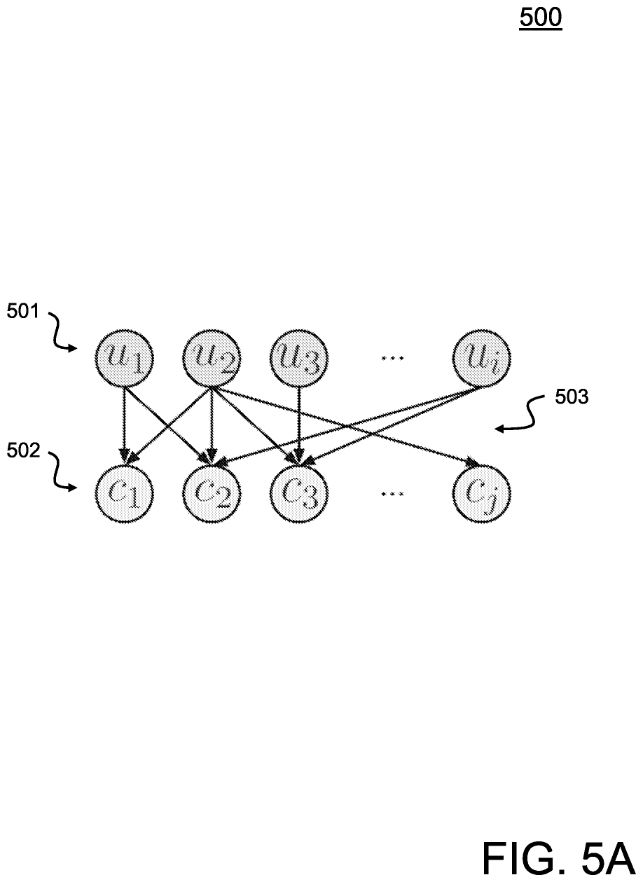

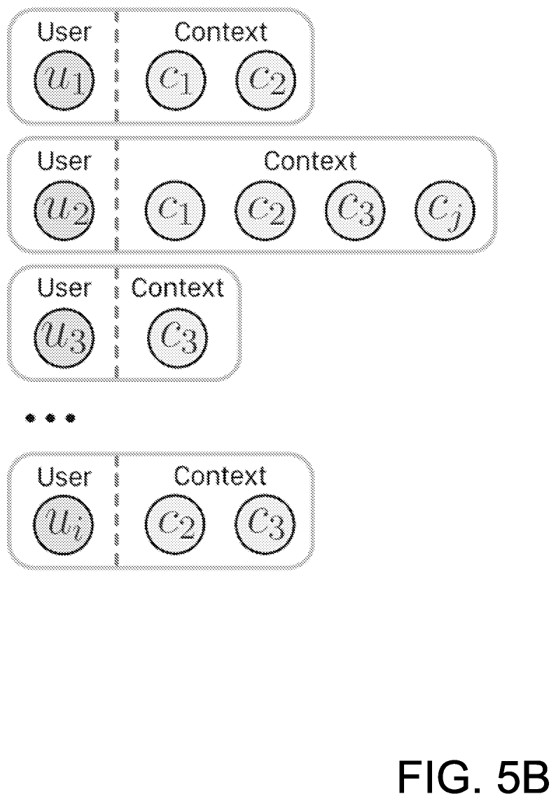

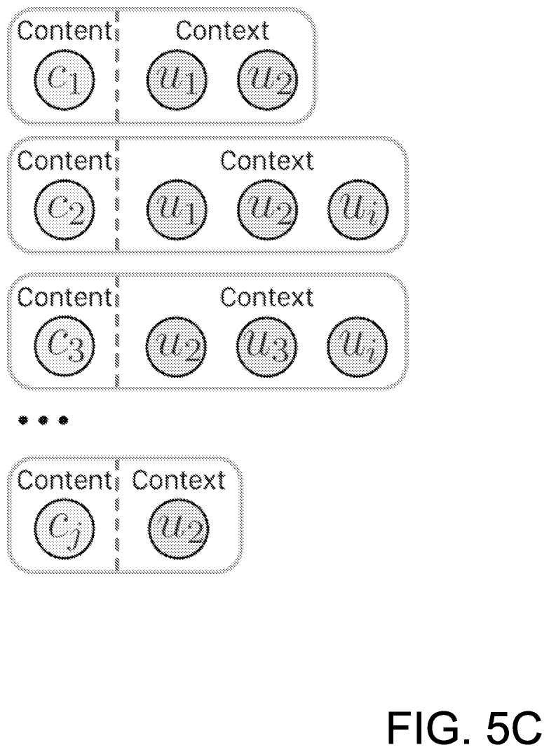

Referring now to FIG. 5A, shown is a schematic diagram of an example bipartite graph 500, according to some non-limiting embodiments or aspects. In some non-limiting embodiments or aspects, graph data associated with bipartite graph 500 may be stored (e.g., by machine learning model system 102, data storage system 104, and/or user device 106). In some non-limiting embodiments or aspects, graph data associated with bipartite graph 500 may be received (e.g., by machine learning model system 102 from data storage system 104 and/or user device 106). As shown in FIG. 5, bipartite graph 500 may include a plurality of first nodes 501 (e.g., i first nodes), a plurality of second nodes 502 (e.g., j second nodes), and a plurality of edges 503.

In some non-limiting embodiments or aspects, each first node 501 of the plurality of first nodes 501 may be associated with a first entity (e.g., user) of a plurality of first entities (e.g. users u₁, u₂, u₃, . . . , uᵢ). Additionally or alternatively, each second node 502 of the plurality of second nodes 502 may be associated with a second entity (e.g., content) of a plurality of second entities (e.g., contents c₁, c₂, c₃, . . . , cⱼ). In some non-limiting embodiments or aspects, each edge 503 of the plurality of edges 503 may be associated with an interaction between a respective first entity (e.g., user) and a respective second entity (e.g., content).

In some non-limiting embodiments or aspects, a bipartite graph [symbol] may be represented as [symbol] ={ [symbol] , [symbol] , ε}, wherein [symbol] is the vertex (e.g., node) set of first entities (e.g., users) such that uᵢ∈ [symbol] , [symbol] is the vertex (e.g., node) of second entities (e.g., contents) such that cⱼ∈ [symbol] , and ε is the set such that each edge e_{i,j}=(uᵢ, cⱼ) represents an interaction between user first entity uᵢ and second entity cⱼ.

Referring now to FIGS. 5B and 5C, and with continued reference to FIG. 5A, FIGS. 5B and 5C show schematic diagrams of example contexts for entities of bipartite graph 500, according to some non-limiting embodiments or aspects.

In some non-limiting embodiments or aspects, as shown in FIG. 5B, a first entity context of each first entity (e.g. user) of the plurality of first entities (e.g. users u₁, u₂, u₃, . . . , uᵢ) may include all second entities (e.g., contents) connected thereto by at least one edge 503 of the plurality of edges 503 of bipartite graph 500.

In some non-limiting embodiments or aspects, a first entity context (e.g., user behavior history Uᵢ of a user uᵢ) may be represented as a vector of edges (e.g., Uᵢ=(eᵢ₁, . . . , eᵢₙ), where c₁, . . . , cₙ are the corresponding contents that have interactions with user uᵢ through edges). In some non-limiting embodiments or aspects, e₁ⱼ may be a multivariate vector, if the edge has attributes. In some non-limiting embodiments or aspects, to simplify notation, user behavior history Uᵢ may be denoted as (c₁, . . . , cₙ), e.g., where there are no attributes associated with each edge eᵢⱼ.

In some non-limiting embodiments or aspects, as shown in FIG. 5C, a second entity context of each second entity (e.g., content) of the plurality of second entities (e.g., contents c₁, c₂, c₃, . . . , cⱼ) may include all first entities (e.g., users) connected thereto by at least one edge 503 of the plurality of edges 503 of bipartite graph 500.

In some non-limiting embodiments or aspects, a second entity context (e.g., content history Cⱼ of a content cⱼ) may be represented as a vector of edges (e.g., Cⱼ=(e₁ⱼ, . . . , eₙⱼ), where u₁, . . . , uₙ are the corresponding users that have interactions with content cⱼ through edges). In some non-limiting embodiments or aspects, to simplify notation, content history Cⱼ may be denoted as (u₁, . . . , uₙ), e.g., if cⱼ is univariate.

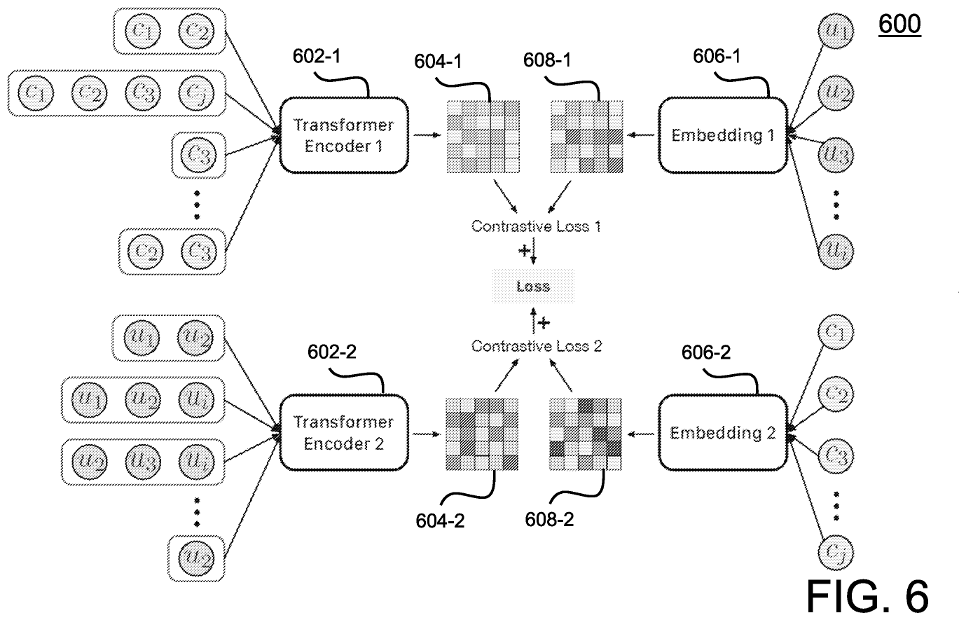

Referring now to FIG. 6, shown is a schematic diagram of an example implementation 600 of pretrained dual transformers for bipartite graphs, according to some non-limiting embodiments or aspects. The components shown in FIG. 6 are for example purposes only. It will be appreciated that additional, fewer, different, and/or a different order of components may be used in non-limiting embodiments or aspects. In some non-limiting embodiments or aspects, implementation 600 may be implemented (e.g., completely, partially, and/or the like) by machine learning model system 102 (e.g., one or more devices of machine learning model system 102). In some non-limiting embodiments or aspects, implementation 600 may be implemented (e.g., completely, partially, and/or the like) by another system, another device, another group of systems, or another group of devices, separate from or including machine learning model system 102, such as data storage system 104, user device 106, and/or the like.

In some non-limiting embodiments or aspects, first embedding layer 606-1 may generate a plurality of first embeddings 608-1, as described herein. For example, first embeddings 608-1 may include a respective first embedding associated with each first entity (e.g., user) of the plurality of first entities (e.g., users u₁, u₂, u₃, . . . , uᵢ associated with first nodes 501 of bipartite graph 500).

In some non-limiting embodiments or aspects, first transformer encoder 602-1 may generate a plurality of first encoded representations 604-1, as described herein. For example, first encoded representations 604-1 may include a respective first encoded representation associated with each first entity (e.g., user) of the plurality of first entities (e.g., users u₁, u₂, u₃, . . . , uᵢ associated with first nodes 501 of bipartite graph 500), which may be generated based on the first entity context of each first entity (e.g., by inputting the first entity context to first transformer encoder 602-1 to generate the respective first encoded representation).

In some non-limiting embodiments or aspects, second embedding layer 606-2 may generate a plurality of second embeddings 608-2, as described herein. For example, second embeddings 608-2 may include a respective second embedding associated with each second entity (e.g. content) of the plurality of second entities (e.g., contents c₁, c₂, C₃, . . . , cⱼ associated with second nodes 502 of bipartite graph 500).

In some non-limiting embodiments or aspects, second transformer encoder 602-2 may generate a plurality of second encoded representations 604-2, as described herein. For example, second encoded representations 604-2 may include a respective second encoded representation associated with each second entity (e.g., content) of the plurality of second entities (e.g., contents c₁, c₂, c₃, . . . , cⱼ associated with second nodes 502 of bipartite graph 500), which may be generated based on the second entity context of each second entity (e.g., by inputting the second entity context to second transformer encoder 602-2 to generate the respective second encoded representation).

In some non-limiting embodiments or aspects, the embedding of a user uᵢ may be denoted as emb(uᵢ). The context of the user uᵢ (e.g., in the form of the user behavior history Uᵢ) may be a heterogeneous representation of the same entity (e.g., user uᵢ) as the embedding emb(uᵢ).

In some non-limiting embodiments or aspects, the embedding of a content Cⱼ may be denoted as emb(cⱼ). The context of the content cⱼ(e.g., in the form of content history Cⱼ) may be a heterogeneous representation of the same entity (e.g., content cⱼ) as the embedding emb(cⱼ).

In some non-limiting embodiments or aspects, learning (e.g., pretraining) may match the two representations (e.g., embeddings and contexts), thereby providing a bi-directional mapping between the spaces of users and contents. For example, a goal of pretraining may be to jointly increase (e.g., maximize) the mutual information I(Uᵢ; emb(uᵢ)) and I(Cⱼ; emb(cⱼ)). For example, an objective of pretraining may be to maximize the following equation:

I=I(Uᵢ;emb(uᵢ))+I(Cⱼ;emb(cⱼ)) Equation 1

In some non-limiting embodiments or aspects, the mutual information I may be defined based on the following equation:

$$I ( X ; Y ) = {\sum }_{y ∈ Y} {\sum }_{x ∈ X} P ( x , y ) log \frac{P ( x , y )}{P ( x ) P ( y )} \qquad Equation 2$$

In some non-limiting embodiments or aspects, given an edge eᵢⱼ from a time-aware bipartite graph, the user behavior history Uᵢ of the user uᵢ and the content history Cⱼ of the content cⱼ before the timestamp of edge eᵢⱼ, an objective of pretraining may be to learn how to map Uᵢ and the embedding of uᵢ to proximate regions in a latent space (e.g., first latent space, user latent space, and/or the like) and to map Cⱼ and the embedding of cⱼ to proximate regions in a separate latent space (e.g., second latent space, content latent space, and/or the like). For example, a dual transformer model may include four parts: (1) The user embedding layer fᵤ (e.g., first embedding layer 606-1), (2) the content embedding layer f_{c} (e.g., second embedding layer 606-2), (3) the user history encoder gᵤ (e.g., first transformer encoder 602-1) and (4) the content history encoder g_{c} (e.g., second transformer encoder 602-2).

In some non-limiting embodiments or aspects, the user history encoder gᵤ(e.g., first transformer encoder 602-1) may include a multi-head transformer encoder. Given a user uᵢ, the user history encoder gᵤ may receive uᵢ's behavior history Uᵢ=(f_{c}(c₁), . . . , f_{c}(cⱼ)) as input and output a classification token (e.g., CLS token) as an encoded representation of Uᵢ. For example, this output may be denoted as gᵤ(Uᵢ).

In some non-limiting embodiments or aspects, the content history encoder g_{c}(e.g., second transformer encoder 602-2) may include a multi-head transformer encoder. Given a user cⱼ, the content history encoder g_{c} may receive cⱼ's history Cⱼ=(fᵤ(u₁), . . . , fᵤ(uᵢ)) as input and output a classification token (e.g., CLS token) as an encoded representation of Cⱼ. For example, this output may be denoted as g_{c}(Cⱼ).

In some non-limiting embodiments or aspects, a first contrastive loss (e.g., Contrastive Loss 1) between the plurality of first embeddings 608-1 and the plurality of first encoded representations 604-1 may be determined (e.g., by machine learning model system 102).

In some non-limiting embodiments or aspects, given an edge eᵢⱼ, the contrastive loss [symbol] ᵤ between the user behavior history Uᵢ (e.g., the encoded representation gᵤ(Uᵢ) of the user behavior history Uᵢ) and the user embedding fᵤ(uᵢ) may be determined based on the following equation:

$${ℒ}_{u} = − log \frac{exp [ sim ( {f}_{u} ( {u}_{i} ) , {g}_{u} ( {U}_{i} ) ) ]}{{\sum }_{k = 1}^{N} {\text{?}}_{[ k \neq i ]} exp [ sim ( {f}_{u} ( {u}_{k} ) , {g}_{u} ( {U}_{i} ) ) ]} \qquad Equation 3$$

where sim is the cosign similarity (e.g., inner product) and exp is the exponential function.

In some non-limiting embodiments or aspects, a second contrastive loss (e.g., Contrastive Loss 2) between the plurality of second embeddings 608-2 and the plurality of second encoded representations 604-2 may be determined (e.g., by machine learning model system 102). In some non-limiting embodiments or aspects, a total loss may be determined based on the first contrastive loss (e.g., Contrastive Loss 1) and the second contrastive loss (e.g., Contrastive Loss 2).

In some non-limiting embodiments or aspects, given an edge eᵢⱼ, the contrastive loss [symbol] _{c} between the content history C₁ (e.g., the encoded representation g_{c}(Cⱼ) of the content history Cⱼ) and the content embedding f_{c}(cⱼ) may be determined based on the following equation:

$${ℒ}_{c} = − log \frac{exp [ sim ( {f}_{c} ( {c}_{j} ) , {g}_{c} ( {C}_{j} ) ) ]}{{\sum }_{k = 1}^{N} {\text{?}}_{[ k \neq i ]} exp [ sim ( {f}_{c} ( {c}_{k} ) , {g}_{c} ( {C}_{j} ) ) ]} \qquad Equation 4$$

In some non-limiting embodiments or aspects, the plurality of first embeddings 608-1 and/or the first transformer encoder 602-1 may be adjusted based on at least one of the first contrastive loss, the total loss, or any combination thereof.

In some non-limiting embodiments or aspects, the plurality of second embeddings 608-2 and/or the second transformer encoder 602-2 may be adjusted based on the second contrastive, the total loss, or any combination thereof.

In some non-limiting embodiments or aspects, determining of the contrastive losses and adjusting of the transformer encoders and/or embeddings, as described herein, may be referred to as pretraining (e.g., performing a pretraining task).

In some non-limiting embodiments or aspects, after pretraining, the pretrained dual transformer model (e.g., at least one of first transformer encoder 602-1 and/or second transformer encoder 602-2) may be used to perform at least one task (e.g., a downstream task). For example, the downstream task(s) may include generating at least one classification, prediction, fraud detection, risk detection, transaction authorization, credit approval, product recommendation, classification, anomaly detection, authentication, any combination thereof, and/or the like.

For the purpose of illustration, the downstream task may include a recommendation. For example, given the user embedding fᵤ(uᵢ) and user behavior history Uᵢ of a user uᵢ, a recommendation may include predicting the next item cₙₑₓₜ with which the user uᵢ may interact. In some non-limiting embodiments or aspects, the user embedding fᵤ(uᵢ) may have learned some long-term patterns in the pre-training, e.g., based on the contrastive loss [symbol] ᵤ. Additionally or alternatively, the recent user behavior history Uᵢ may capture some short-term but time-aware patterns. As such, by jointly using the user embedding fᵤ(uᵢ) and the user behavior history Uᵢ, the different patterns (e.g., long- and short-term patterns) may be combined, and use of computation resources may be reduced (e.g., because there is no need to process the long history sequence of the user uᵢ).

In some non-limiting embodiments or aspects, for this illustrative downstream task, the user embedding fᵤ(uᵢ) may be encoded by the encoder g_{c}, and the resulting output may be concatenated with the recent user behavior history Uᵢ. The result of the concatenation may be further encoded by gᵤ to provide the final representation yᵢ. For example, yᵢ may be determined based on the following equation:

[symbol]

ᵢ=gᵤ[g_{c}(fᵤ(uᵢ)),Uᵢ] Equation 5

In some non-limiting embodiments or aspects, the inner product

$${y}_{i}^{T} \cdot {f}_{c} ( c )$$

may be used to measure how likely a user uᵢ would be to interact with item c. In some non-limiting embodiments or aspects, the pretrained dual transformer model (e.g., the transformer encoders thereof) may be finetuned based on at least one loss (e.g., at least one of the contrastive loss [symbol] ᵤ, the contrastive loss [symbol] _{c}, a Bayesian personalized ranking (BPR) loss [symbol] _{BPR}, any combination thereof, and/or the like). For example, a BPR loss [symbol] _{BPR} may be determined based on the following equation:

$${ℒ}_{BPR} = − log [ σ ( {y}_{i}^{T} \cdot {f}_{c} ( {c}_{pos} ) ) − σ ( {y}_{i}^{T} \cdot {f}_{c} ( {c}_{neg} ) ) ] \qquad Equation 6$$

where σ is the sigmoid function and cₚₒₛ and c_{neg} are the positive and negative samples of the next item, respectively.

In some non-limiting embodiments or aspects, the total loss [symbol] ₜₒₜₐₗ (e.g., for finetuning) may be determined based on the contrastive loss [symbol] ᵤ, the contrastive loss [symbol] _{c}, and the BPR loss [symbol] _{BPR}. For example, the total loss [symbol] ₜₒₜₐₗ may be determined based on the following equation:

[symbol]

ₜₒₜₐₗ= [symbol] _{BPR}+ [symbol] ᵤ_{ᵢ}+ [symbol] _{c}_{ⱼ} Equation 7

For the purpose of illustration, Table 1 shows performance (e.g., based on recall and normalized discounted cumulative gain (NDCG) metrics) of an example pretrained dual transformer (PDT), as described herein, compared to other general (e.g., BPR-MF, NeuMF, NGCF, and LightGCN) and sequential (e.g., GRU4Rec, Caser, SASRec, and SRGNN) recommender models for a recommendation (downstream) task. As shown in Table 1, PDT outperforms the other recommender models.

TABLE 1

| | Recall @ | Recall @ | Recall @ | NDCG @ | NDCG @ | NDCG @ |
|---|---|---|---|---|---|---|
| Model | 10 | 20 | 50 | 10 | 20 | 50 |
| BPR-MF | 0.0710 | 0.1215 | 0.2324 | 0.0349 | 0.0476 | 0.0695 |
| NeuMF | 0.0778 | 0.1340 | 0.2524 | 0.0380 | 0.0521 | 0.0754 |
| NGCF | 0.0712 | 0.1202 | 0.2282 | 0.0353 | 0.0476 | 0.0688 |
| LightGCN | 0.0824 | 0.1381 | 0.2548 | 0.0412 | 0.0551 | 0.0781 |
| GRU4Rec | 0.0979 | 0.1660 | 0.3021 | 0.0466 | 0.0637 | 0.0905 |
| Caser | 0.0809 | 0.1409 | 0.2686 | 0.0383 | 0.0533 | 0.0785 |
| SASRec | 0.0940 | 0.1634 | 0.3033 | 0.0446 | 0.0620 | 0.0896 |
| SRGNN | 0.0992 | 0.1591 | 0.2777 | 0.0508 | 0.0658 | 0.0892 |
| PDT | 0.1076 | 0.1783 | 0.3190 | 0.0532 | 0.0709 | 0.0987 |

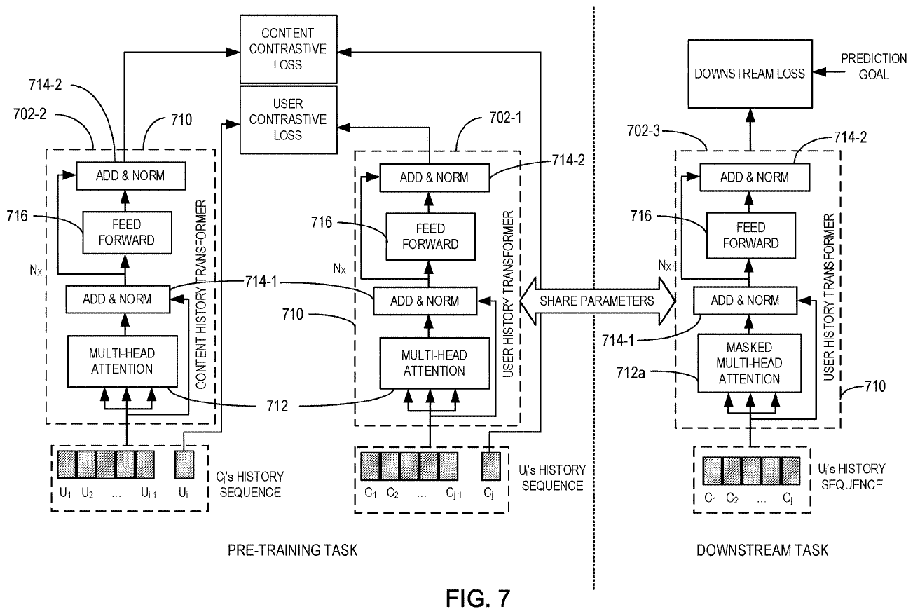

Referring now to FIG. 7, shown is a schematic diagram of an example implementation 700 of pretrained dual transformers for bipartite graphs, according to some non-limiting embodiments or aspects. The components shown in FIG. 7 are for example purposes only. It will be appreciated that additional, fewer, different, and/or a different order of components may be used in non-limiting embodiments or aspects. In some non-limiting embodiments or aspects, implementation 700 may be implemented (e.g., completely, partially, and/or the like) by machine learning model system 102 (e.g., one or more devices of machine learning model system 102). In some non-limiting embodiments or aspects, implementation 700 may be implemented (e.g., completely, partially, and/or the like) by another system, another device, another group of systems, or another group of devices, separate from or including machine learning model system 102, such as data storage system 104, user device 106, and/or the like. In some non-limiting embodiments or aspects, first transformer encoder 702-1 may be the same as or similar to first transformer encoder 602-1. In some non-limiting embodiments or aspects, second transformer encoder 702-2 may be the same as or similar to second transformer encoder 602-2. In some non-limiting embodiments or aspects, third transformer encoder 702-3 may be the same as or similar to first transformer encoder 602-1 and/or first transformer encoder 702-1. For example, third transformer encoder 702-3 may share parameters with first transformer encoder 702-1, but third transformer encoder 702-3 may have slight differences from first transformer encoder 702-1, as described herein. In some non-limiting embodiments or aspects, first transformer encoder 702-1, second transformer encoder 702-2, and third transformer encoder 702-3 may be referred to collectively as “transformer encoders 702” or individually as “transformer encoder 702.”

In some non-limiting embodiments or aspects, each transformer encoder 702 may include a plurality of transformer layers 710 (e.g., N transformer layers). Each transformer layer 710 may include at least one multi-head attention network 712 (or masked multi-head attention network 712a), at least one addition and normalization (Add&Norm) layer (e.g., first Add&Norm layer 714-1 and second Add&Norm layer 714-2, collectively referred to as “Add&Norm layers 714,” and individually referred to as “Add&Norm layer 714”), and at least one feed forward network 716 (e.g., including at least one neural network layer, such as a fully connected neural network layer and/or the like). For example, each transformer layer 710 may include multi-head attention network 712 (or masked multi-head attention network 712a) that receives the input to that transformer layer 710, first Add&Norm layer 714-1 that receives the output of multi-head attention network 712 (or masked multi-head attention network 712a) and receives the input to that transformer layer 710 (e.g., via a residual connection), feed forward network 716 that receives the output of first Add&Norm layer 714-1, and second Add&Norm layer 714-2 that receives the output of feed forward network 716 and receives the output of first Add&Norm layer 714-1 (e.g., via a residual connection).

In some non-limiting embodiments or aspects, the input to the first transformer layer 710 of each transformer encoder 702 may include the entity context of a respective entity (and/or embeddings of the entities in the entity context of the respective entity). For example, as shown in FIG. 7, the input to the first transformer layer 710 of first transformer encoder 702-1 may include the context of a user uᵢ (e.g., the history sequence of contents c₁, c₂, c₃, . . . , cⱼ (and/or embeddings thereof) associated with user uᵢ). For example, as shown in FIG. 7, the input to the first transformer layer 710 of second transformer encoder 702-2 may include the context of a content cⱼ (e.g., the history sequence of users u₁, u₂, u₃, . . . , uᵢ (and/or embeddings thereof) associated with content cⱼ). For example, as shown in FIG. 7, the input to the first transformer layer 710 of third transformer encoder 702-3 may include the context of a user uᵢ (e.g., the history sequence of contents c₁, c₂, c₃, . . . , cⱼ(and/or embeddings thereof) associated with user uᵢ).

In some non-limiting embodiments or aspects, the input to each subsequent transformer layer 710 of each transformer encoder 702 (e.g., after the first transformer layer 710) may include the output of the preceding transformer layer 710. For example, the input to the second transformer layer 710 may include the output of the first transformer layer 710, etc.

In some non-limiting embodiments or aspects, a first contrastive loss (e.g., User Contrastive Loss) between an embedding for a user uᵢ and the encoded representation for the user uᵢ output from first transformer encoder 702-1 may be determined (e.g., by machine learning model system 102), as described herein. In some non-limiting embodiments or aspects, the User Contrastive Loss (e.g., [symbol] ᵤ) may be determined based on Equation 3.

In some non-limiting embodiments or aspects, the embedding for a user uᵢ and/or first transformer encoder 702-1 may be adjusted (e.g., the parameters thereof may be updated) based on the first contrastive loss (e.g., User Contrastive Loss). For example, machine learning model system 102 may update (e.g., adjust) the parameters of first transformer encoder 702-1 based on back propagation (e.g., of the loss), gradient calculations (e.g., based on the loss), any combination thereof, and/or the like.

In some non-limiting embodiments or aspects, a second contrastive loss (e.g., Content Contrastive Loss) between an embedding for a content cⱼ and the encoded representation for the content cⱼ may be determined (e.g., by machine learning model system 102), as described herein. In some non-limiting embodiments or aspects, the Content Contrastive Loss (e.g., [symbol] _{c}) may be determined based on Equation 4.

In some non-limiting embodiments or aspects, the embedding for a content cⱼ and/or second transformer encoder 702-2 may be adjusted (e.g., the parameters thereof may be updated) based on the second contrastive loss (e.g., Content Contrastive Loss). For example, machine learning model system 102 may update (e.g., adjust) the parameters of second transformer encoder 702-2 based on back propagation (e.g., of the loss), gradient calculations (e.g., based on the loss), any combination thereof, and/or the like.

In some non-limiting embodiments or aspects, determining of the contrastive losses and adjusting of the transformer encoders 702 and/or embeddings, as described herein, may be referred to as pretraining (e.g., performing a pretraining task).

In some non-limiting embodiments or aspects, after pretraining, the parameters of first transformer encoder 702-1 may be shared with third transformer encoder 702-3.

In some non-limiting embodiments or aspects, third transformer encoder 702-3 may perform at least one task (e.g., a downstream task). For example, the downstream task(s) may include generating at least one classification, prediction, fraud detection, risk detection, transaction authorization, credit approval, product recommendation, classification, anomaly detection, authentication, any combination thereof, and/or the like.

In some non-limiting embodiments or aspects, the output of third transformer encoder 702-3 may be input to a machine learning model (e.g., downstream machine learning model) to perform at least one task (e.g., a downstream task). For example, the downstream machine learning model may include at least one of a classifier, a predictor, a fraud detection model, a risk detection model, a transaction authorization model, a credit approval model, a product recommendation model, a classifier model, an anomaly detection model, an authentication model, any combination thereof, and/or the like. In some non-limiting embodiments or aspects, the downstream machine learning model may include at least one of a neural network, a convolutional neural network, a recurrent neural network, an autoencoder (or portion thereof), a long short-term memory (LSTM), a bidirectional LSTM, an attention network, a transformer, any combination thereof, and/or the like.

In some non-limiting embodiments or aspects, a loss (e.g., Downstream Loss) may be determined (e.g., by machine learning model system 102) based on the output (e.g., prediction and/or the like) of third transformer encoder 702-3 (and/or the output of the downstream machine learning model) and a prediction goal. For example, the prediction goal may include a label, a known value, an actual value, any combination thereof, and/or the like.

In some non-limiting embodiments or aspects, the parameters of third transformer encoder 702-3 may be adjusted (e.g., updated) based on the loss (e.g., Downstream Loss). For example, machine learning model system 102 may update (e.g., adjust) the parameters of third transformer encoder 702-3 (and/or the downstream machine learning model) based on back propagation (e.g., of the loss), gradient calculations (e.g., based on the loss), any combination thereof, and/or the like.

In some non-limiting embodiments or aspects, the parameters of first transformer encoder 702-1 may be denoted as gᵤ, second transformer encoder 702-2 may be denoted as g_{c}, and third transformer encoder 702-3 may be denoted as gᵣ. For the purpose of illustration, the downstream task may include a recommendation, as described herein. For example, the final representation yᵢ (e.g., the predicted content) may be determined based on the following equation:

[symbol]

ᵢ=gᵣ(Uᵢ) Equation 8

In some non-limiting embodiments or aspects, the BPR loss [symbol] _{BPR} may be determined based on Equation (e.g., using the yᵢ from Equation 8 rather than Equation 5).

In some non-limiting embodiments or aspects, the total loss [symbol] ₜₒₜₐₗ may be determined based on the following equation:

[symbol]

ₜₒₜₐₗ= [symbol] _{BPR}+λᵤ· [symbol] ᵤ_{ᵢ}+λ_{c}· [symbol] _{c}_{ⱼ} Equation 9

where λᵤ and λ_{c} are hyper-parameters controlling the weights of contrastive losses. In some non-limiting embodiments or aspects, the hyper-parameters λᵤ and λ_{c} may be determined based on hyper-parameter tuning (e.g., grid search and/or the like). For example, the hyper-parameters could have values such as λᵤ=0.01 and λ_{c}=0.05.

In some non-limiting embodiments or aspects, determining of the loss and adjusting of the third transformer encoder 702-3 (and/or the downstream machine learning model), as described herein, may be referred to as finetuning (e.g., finetuning third transformer encoder 702-3 to perform the downstream task).

For the purpose of illustration, Table 2 shows performance (e.g., based on recall and NDCG metrics) of example pretrained dual transformers, as described herein, with feed forward network (hidden) dimension of 128 (PDT-Small) and 512 (PDT-Large) compared to other general (e.g., BPR-MF, NeuMF, NGCF, and LightGCN) and sequential (e.g., GRU4Rec, Caser, SASRec-Small, SASRec-Large, GCSAN, and SRGNN) recommender models for a recommendation (downstream) task. As shown in Table 2, PDT-Small and PDRT-Large outperforms the other recommender models.

TABLE 2

| | Recall @ | Recall @ | Recall @ | NDCG @ | NDCG @ | NDCG @ |
|---|---|---|---|---|---|---|
| Model | 10 | 20 | 50 | 10 | 20 | 50 |
| BPR-MF | 0.0710 | 0.1215 | 0.2324 | 0.0349 | 0.0476 | 0.0695 |
| NeuMF | 0.0778 | 0.1340 | 0.2524 | 0.0380 | 0.0521 | 0.0754 |
| NGCF | 0.0712 | 0.1202 | 0.2282 | 0.0353 | 0.0476 | 0.0688 |
| LightGCN | 0.0824 | 0.1381 | 0.2548 | 0.0412 | 0.0551 | 0.0781 |
| GRU4Rec | 0.1109 | 0.1839 | 0.3231 | 0.0527 | 0.0711 | 0.0985 |
| Caser | 0.0929 | 0.1602 | 0.2953 | 0.0439 | 0.0608 | 0.0875 |
| SASRec- | 0.0940 | 0.1634 | 0.3033 | 0.0446 | 0.0620 | 0.0896 |
| Small | | | | | | |
| SASRec- | 0.1179 | 0.1929 | 0.3337 | 0.0528 | 0.0716 | 0.0995 |
| Large | | | | | | |
| GCSAN | 0.1234 | 0.2014 | 0.3468 | 0.0593 | 0.0789 | 0.1077 |
| SRGNN | 0.1261 | 0.1987 | 0.3316 | 0.0634 | 0.0817 | 0.1079 |
| PDT-Small | 0.1419 | 0.2176 | 0.3566 | 0.0749 | 0.0939 | 0.1214 |
| PDT-Large | 0.1461 | 0.2206 | 0.3559 | 0.0793 | 0.0980 | 0.1248 |

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges;
generating, with at least one processor, a plurality of first embeddings comprising a respective first embedding associated with each first entity of the plurality of first entities;
generating, with at least one processor, a plurality of first encoded representations comprising a respective first encoded representation associated with each first entity of the plurality of first entities based on the first entity context of each first entity of the plurality of first entities and a first transformer encoder;
generating, with at least one processor, a plurality of second embeddings comprising a respective second embedding associated with each second entity of the plurality of second entities;
generating, with at least one processor, a plurality of second encoded representations comprising a respective second encoded representation associated with each second entity of the plurality of second entities based on the second entity context of each second entity of the plurality of second entities and a second transformer encoder;
adjusting, with at least one processor, the plurality of first embeddings and the first transformer encoder based on a first contrastive loss between the plurality of first embeddings and the plurality of first encoded representations; and
adjusting, with at least one processor, the plurality of second embeddings and the second transformer encoder based on a second contrastive loss between the plurality of second embeddings and the plurality of second encoded representations.

2. The method of claim 1, further comprising:
iteratively repeating, with at least one processor, generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

3. The method of claim 1, further comprising:
generating, with at least one processor, a prediction based on the first embedding of a selected first entity of the plurality of first entities, the first entity context of the selected first entity, the first transformer encoder, and the second transformer encoder.

4. The method of claim 3, further comprising:
adjusting, with at least one processor, the plurality of first embeddings, the first transformer encoder, the plurality of second embeddings, and the second transformer encoder based on a total loss determined based on the prediction.

5. The method of claim 4, further comprising:
iteratively repeating, with at least one processor, generating the prediction and adjusting the plurality of first embeddings, the first transformer encoder, the plurality of second embeddings, and the second transformer encoder until at least one termination condition is satisfied.

6. The method of claim 3, wherein the prediction comprises a sequential prediction.

7. The method of claim 1, wherein the plurality of first entities comprises a plurality of users, and wherein the plurality of second entities comprises a plurality of contents.

8. The method of claim 1, wherein generating the plurality of first embeddings comprises randomly initializing the plurality of first embeddings.

9. The method of claim 1, wherein generating the plurality of second embeddings comprises randomly initializing the plurality of second embeddings.

10. A system, comprising:
at least one processor configured to:
receive graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges;
generate a plurality of first embeddings comprising a respective first embedding associated with each first entity of the plurality of first entities;
generate a plurality of first encoded representations comprising a respective first encoded representation associated with each first entity of the plurality of first entities based on the first entity context of each first entity of the plurality of first entities and a first transformer encoder;
generate a plurality of second embeddings comprising a respective second embedding associated with each second entity of the plurality of second entities;
generate a plurality of second encoded representations comprising a respective second encoded representation associated with each second entity of the plurality of second entities based on the second entity context of each second entity of the plurality of second entities and a second transformer encoder;
adjust the plurality of first embeddings and the first transformer encoder based on a first contrastive loss between the plurality of first embeddings and the plurality of first encoded representations; and
adjust the plurality of second embeddings and the second transformer encoder based on a second contrastive loss between the plurality of second embeddings and the plurality of second encoded representations.

11. The system of claim 10, wherein the at least one processor is further configured to:
iteratively repeat generating the plurality of first encoded representations, generating the plurality of second encoded representations, adjusting the plurality of first embeddings and the first transformer encoder, and adjusting the plurality of second embeddings and the second transformer encoder until at least one termination condition is satisfied.

12. The system of claim 10, wherein the at least one processor is further configured to:
generate a prediction based on the first embedding of a selected first entity of the plurality of first entities, the first entity context of the selected first entity, the first transformer encoder, and the second transformer encoder.

13. The system of claim 12, wherein the at least one processor is further configured to:
adjust the plurality of first embeddings, the first transformer encoder, the plurality of second embeddings, and the second transformer encoder based on a total loss determined based on the prediction.

14. The system of claim 13, wherein the at least one processor is further configured to:
iteratively repeat generating the prediction and adjusting the plurality of first embeddings, the first transformer encoder, the plurality of second embeddings, and the second transformer encoder until at least one termination condition is satisfied.

15. The system of claim 12, wherein the prediction comprises a sequential prediction.

16. The system of claim 10, wherein the plurality of first entities comprises a plurality of users, and wherein the plurality of second entities comprises a plurality of contents.

17. The system of claim 10, wherein generating the plurality of first embeddings comprises randomly initializing the plurality of first embeddings.

18. The system of claim 10, wherein generating the plurality of second embeddings comprises randomly initializing the plurality of second embeddings.

19. A computer program product comprising at least one non-transitory computer-readable medium including program instructions that, when executed by at least one processor, cause the at least one processor to:
receive graph data associated with a bipartite graph comprising a plurality of first nodes, a plurality of second nodes, and a plurality of edges, each first node of the plurality of first nodes associated with a first entity of a plurality of first entities, each second node of the plurality of second nodes associated with a second entity of a plurality of second entities, each edge of the plurality of edges associated with an interaction between a respective first entity of the plurality of first entities and a respective second entity of the plurality of second entities, wherein a first entity context of each first entity of the plurality of first entities comprises all second entities of the plurality of second entities connected thereto by at least one edge of the plurality of edges, and wherein a second entity context of each second entity of the plurality of second entities comprises all first entities of the plurality of first entities connected thereto by at least one edge of the plurality of edges;
generate a plurality of first embeddings comprising a respective first embedding associated with each first entity of the plurality of first entities;
generate a plurality of first encoded representations comprising a respective first encoded representation associated with each first entity of the plurality of first entities based on the first entity context of each first entity of the plurality of first entities and a first transformer encoder;
generate a plurality of second embeddings comprising a respective second embedding associated with each second entity of the plurality of second entities;
generate a plurality of second encoded representations comprising a respective second encoded representation associated with each second entity of the plurality of second entities based on the second entity context of each second entity of the plurality of second entities and a second transformer encoder;
adjust the plurality of first embeddings and the first transformer encoder based on a first contrastive loss between the plurality of first embeddings and the plurality of first encoded representations; and
adjust the plurality of second embeddings and the second transformer encoder based on a second contrastive loss between the plurality of second embeddings and the plurality of second encoded representations.

20. The computer program product of claim 19, wherein the instructions, when executed by the at least one processor, further cause the at least one processor to:
generate a prediction based on the first embedding of a selected first entity of the plurality of first entities, the first entity context of the selected first entity, the first transformer encoder, and the second transformer encoder.
